(19) United States
(12) Patent Application Publication
(10) Pub. No.: US 2024/0267659 A1
(43) Pub. Date: Aug. 8, 2024

(54) OPTICAL LINE TERMINAL, OPTICAL ACCESS NETWORK SYSTEM, AND OPTICAL COMMUNICATION METHOD

(71) Applicant: Mitsubishi Electric Corporation, Tokyo (JP)

(72) Inventors: Kenichi Nakura, Tokyo (JP); Takeshi SUEHIRO, Tokyo (JP)

(73) Assignee: Mitsubishi Electric Corporation, Tokyo (JP)

(21) Appl. No.: 18/634,349

(22) Filed: Apr. 12, 2024

Related U.S. Application Data
(63) Continuation of application No. PCT/JP2021/043432, filed on Nov. 26, 2021.

(51) Int. Cl. H04Q 11/00

(52) U.S. Cl. CPC H04Q 11/0067; H04Q 2011/0064; H04Q 2011/0086

(57) ABSTRACT

An ONU operating virtual DBAs that, according to a transmission request, calculate bandwidth to be allocated to a transmission request source and output a transmission grant, and includes a service control unit that generates virtual DBAs according to service requests, a transfer control unit that, when receiving the transmission request, selects the virtual DBA that is a transfer destination of the received transmission request, based on a transfer rule table as transfer rule information indicating the correspondence relationship between the transmission request source and the virtual DBA that is the transfer destination, and transfers the transmission request to the selected virtual DBA, and an aggregation control unit that aggregates the transmission grants output by the virtual DBAs, based on an aggregation rule table as aggregation rule information indicating the correspondence relationships between destinations of the transmission grants and the virtual DBAs that can be transmission sources of the transmission grants.

### CROSS-REFERENCE TO RELATED APPLICATION

This application is a continuation application of International Application PCT/JP2021/043432, filed on Nov. 26, 2021, and designating the U.S., the entire contents of which are incorporated herein by reference.

### BACKGROUND OF THE INVENTION

### 1. Field of the Invention

The present disclosure relates to an optical line terminal that dynamically allocates bandwidth according to transmission requests from optical network units on the subscriber side, an optical access network system, and an optical communication method.

### 2. Description of the Related Art

When multiple services are accommodated by a single communication network, it is necessary to dynamically control parameters related to quality of service (QoS), according to the status of communication and the status of usage, to meet the respective QoS requirements of the services. In the future, multiple services having different requirements for communication are expected to be accommodated by a single communication network. Examples of multiple services having different requirements for communication include a mobile broadband service requiring a high data rate, a mission-critical service requiring high reliability and low latency, and a sensor information gathering service requiring the accommodation of a high-density device.

In optical access networks, broadband services are commonly provided using a passive optical network (PON) scheme. A PON uses, as an access control method, an arrangement in which optical network units (ONUs) on the subscriber side perform transmission requests, and an optical line terminal (OLT) on the operator side provides transmission grants, to avoid data collisions between the ONUs on an optical fiber.

An OLT operates a dynamic bandwidth allocation (DBA) function to periodically receive transmission requests from a plurality of ONUs, dynamically calculate the amounts of transmission data in the respective ONUs according to the transmission requests, and provide transmission grants. The DBA performs control to meet the respective service level agreements (SLAs) of the ONUs.

When multiple services are provided on a PON system, each service may be provided by a different operator, or part of a physical network may be provided as network slices that are logical networks. In such a case, there may arises a desire to control SLA and QoS policies on an individual service basis.

As a means to manage and control multiple SLA and QoS policies on a single system, a method to operate different DBAs for different services has been studied. When a plurality of DBAs are operated on a single system, coordination between the DBAs may be required. Japanese Translation of PCT International Application Laid-open No. 2020-510357 discloses a system that operates a plurality of DBAs and includes a merging engine that merges a plurality of transmission grants generated by the DBAs.

However, the above conventional technique has a problem in that the plurality of DBAs may allocate bandwidth based on the same transmission request, causing a waste of calculation resources of the DBAs, and excessive allocation may occur, causing a waste of bandwidth resources.

The present disclosure has been made in view of the above. It is an object of the present disclosure to provide an optical line terminal capable of reducing resource waste.

### SUMMARY OF THE INVENTION

To solve the problem and achieve the object described above, an optical line terminal on an operator side according to the present disclosure operates a plurality of virtual dynamic bandwidth allocation units to, according to a transmission request transmitted by an optical network unit on a subscriber side, calculate bandwidth to be allocated to a transmission source of the transmission request and output a transmission grant. The optical line terminal includes: a service control unit to generate the plurality of virtual dynamic bandwidth allocation units according to service requests; a transfer control unit to, when receiving the transmission request, select the virtual dynamic bandwidth allocation unit that is a transfer destination of the received transmission request, based on transfer rule information indicating a correspondence relationship between the transmission source of the transmission request and the virtual dynamic bandwidth allocation unit that is the transfer destination, and transfer the transmission request to the selected virtual dynamic bandwidth allocation unit; and an aggregation control unit to aggregate the transmission grants output by the virtual dynamic bandwidth allocation units, based on aggregation rule information indicating correspondence relationships between destinations of the transmission grants and the virtual dynamic bandwidth allocation units that are possibly transmission sources of the transmission grants.

### BRIEF DESCRIPTION OF THE DRAWINGS

FIG. 1 is a diagram illustrating a configuration of an optical access network system according to a first embodiment;

FIG. 2 is a diagram illustrating an example of a format of transmission requests transmitted from ONUs to an OLT illustrated in FIG. 1;

FIG. 3 is a diagram illustrating a detailed functional configuration of the OLT illustrated in FIG. 1;

FIG. 4 is a diagram illustrating an example of a service request received by the OLT illustrated in FIG. 3;

FIG. 5 is a diagram illustrating an example of a transfer rule table illustrated in FIG. 3;

FIG. 6 is a diagram illustrating an example of an aggregation rule table illustrated in FIG. 3;

FIG. 7 is a diagram illustrating an example of a transfer rule table generated by a service control unit according to a second embodiment;

FIG. 8 is a diagram illustrating an example of a transfer rule table generated by a service control unit according to a third embodiment;

FIG. 9 is a diagram illustrating an example of an aggregation rule table generated by the service control unit according to the third embodiment;

FIG. 10 is a functional block diagram of an ONU according to a fourth embodiment;

FIG. 11 is a diagram illustrating an example of a transfer rule table used by an OLT that receives a REPORT frame including transmission requests from the ONU illustrated in FIG. 10;

FIG. 12 is a diagram illustrating dedicated hardware for implementing functions of the OLT and the ONUs according to the first to fourth embodiments; and

FIG. 13 is a diagram illustrating an example of a configuration for implementing functions of the OLT and the ONUs according to the first to fourth embodiments, using a CPU.

### DETAILED DESCRIPTION OF THE PREFERRED EMBODIMENTS

Hereinafter, an optical line terminal, an optical access network system, and an optical communication method according to embodiments of the present disclosure will be described in detail with reference to the drawings.

### First Embodiment

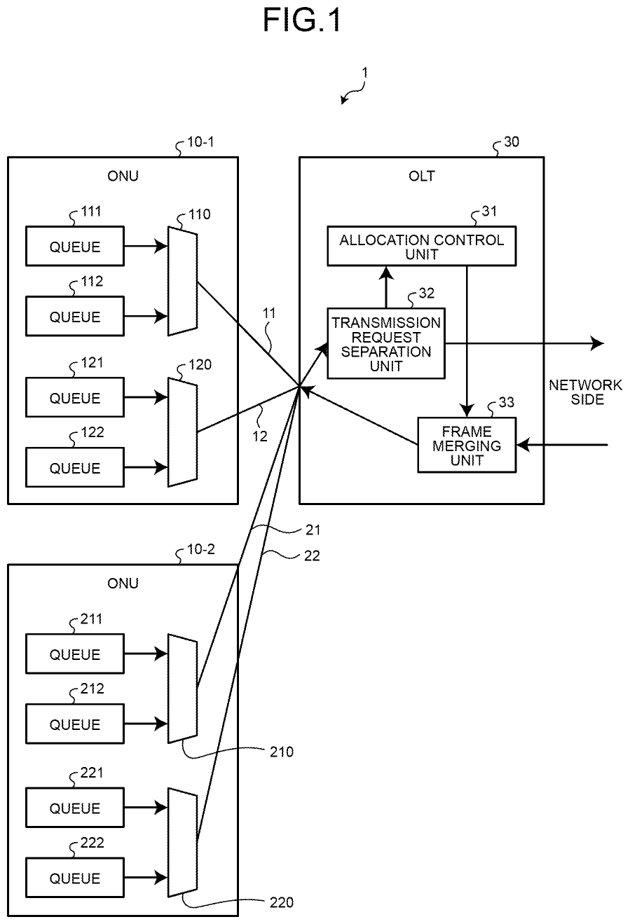

FIG. 1 is a diagram illustrating a configuration of an optical access network system 1 according to a first embodiment. The optical access network system 1 includes a plurality of optical network units (ONUs) 10-1 and 10-2 on the subscriber side, and an optical line terminal (OLT) 30 on the operator side. Hereinafter, when a plurality of components having the same function are distinguished from each other, different reference numerals are attached to a hyphen after a common reference numeral to distinguish them. When it is not necessary to distinguish a plurality of components having the same function from each other, only a common reference numeral may be given. For example, when it is not necessary to distinguish the ONUs 10-1 and 10-2 from each other, they are referred to as the ONUs 10.

The optical access network system 1 is a PON system, in which the OLT 30 and the ONUs 10 are connected by optical fibers. Although transceivers of the OLT 30 and the ONUs 10 are omitted in FIG. 1, the OLT 30 and the ONUs 10 may be connected by one optical fiber or may be connected by a plurality of optical fibers.

The OLT 30 and the ONUs 10 construct logical connections as well as physical connections by the optical fibers. Here, the logical connections are referred to as LLIDs. Each ONU 10 may construct a plurality of LLIDs. In the example of FIG. 1, the ONU 10-1 is connected to the OLT 30 by an LLID 11 and an LLID 12, and the ONU 10-2 is connected to the OLT 30 by an LLID 21 and an LLID 22.

The LLIDs 11, 12, 21, and 22 include queues 111, 112, 121, 122, 211, 212, 221, and 222 for storing data. Specifically, the queues 111 and 112 are connected to the LLID 11 via a frame reading unit 110, the queues 121 and 122 are connected to the LLID 12 via a frame reading unit 120, the queues 211 and 212 are connected to the LLID 21 via a frame reading unit 210, and the queues 221 and 222 are connected to the LLID 22 via a frame reading unit 220. The ONUs 10 transmit the amounts of data in the queues 111, 112, 121, 122, 211, 212, 221, and 222 to the OLT 30 as transmission requests.

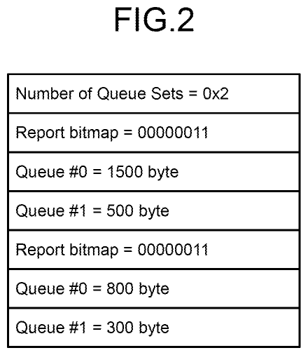

FIG. 2 is a diagram illustrating an example of a format of transmission requests transmitted by the ONUs 10-1 and 10-2 to the OLT 30 illustrated in FIG. 1. FIG. 2 illustrates a format of REPORT information that is transmission requests defined by the IEEE. As illustrated in FIG. 2, transmission requests include the amounts of data in the queues.

The OLT 30 includes an allocation control unit 31, a transmission request separation unit 32, and a frame merging unit 33. The transmission request separation unit 32 of the OLT 30 separates transmission requests from data received by the OLT 30 in which user data frames, transmission requests, etc. are mixed, and outputs the transmission requests to the allocation control unit 31. The allocation control unit 31 calculates the amounts of data to be allocated to the LLIDs, based on the received transmission requests, and generates transmission grants including the allocated amounts of data. The allocation control unit 31 outputs the transmission grants as GATE frames. The frame merging unit 33 multiplexes the GATE frames including the transmission grants output by the allocation control unit 31 and user data received from the network side for transmission to the LLIDs.

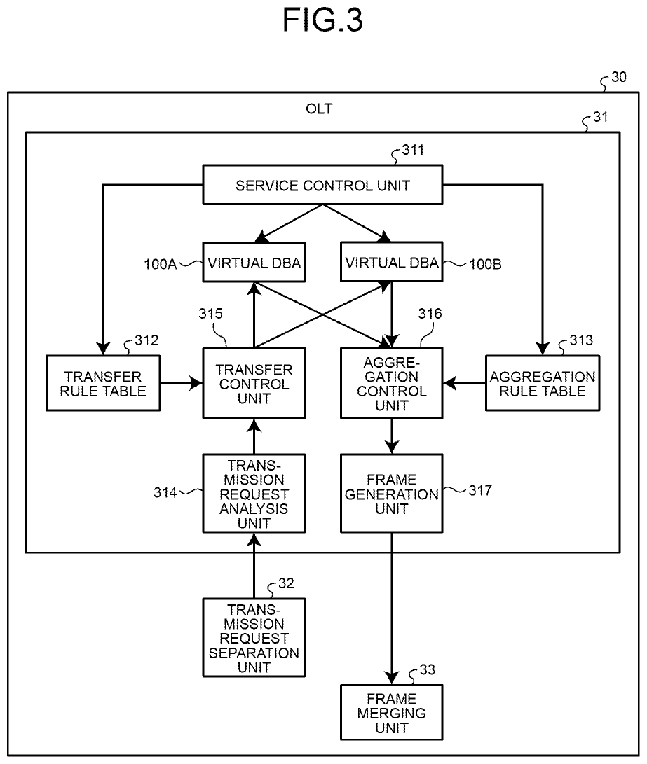

FIG. 3 is a diagram illustrating a detailed functional configuration of the OLT 30 illustrated in FIG. 1. The OLT 30 includes the allocation control unit 31, the transmission request separation unit 32, and the frame merging unit 33. The allocation control unit 31 includes a service control unit 311, a plurality of virtual DBAs 100A and 100B, a transfer rule table 312, an aggregation rule table 313, a transmission request analysis unit 314, a transfer control unit 315, an aggregation control unit 316, and a frame generation unit 317. Hereinafter, when it is not necessary to distinguish the virtual DBAs 100A and 100B from each other, they are simply referred to as the virtual DBAs 100.

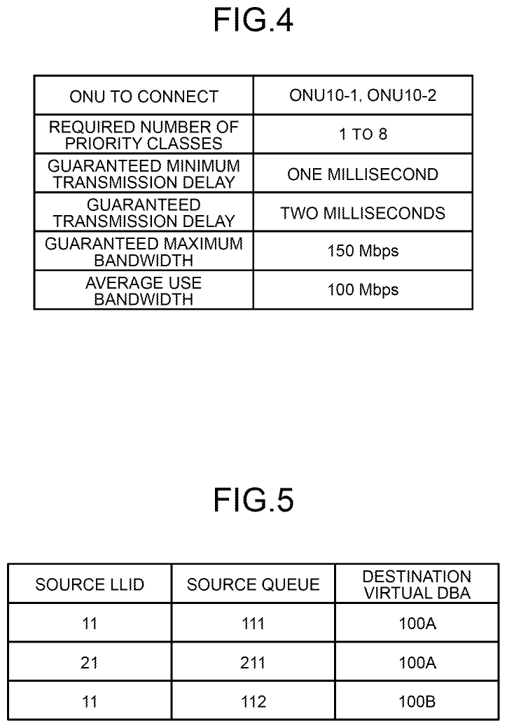

The service control unit 311 receives service requests from network service users. FIG. 4 is a diagram illustrating an example of a service request received by the OLT 30 illustrated in FIG. 3. The service request illustrated in FIG. 4 requires the provision of resources necessary for maintaining the quality of service in which ONUs to connect are the ONU 10-1 and the ONU 10-2, the required number of priority classes is one to eight, guaranteed minimum transmission delay is one millisecond, guaranteed transmission delay is two milliseconds, guaranteed maximum bandwidth is 150 Mbps, and average use bandwidth is 100 Mbps. The service control unit 311 can generate a plurality of virtual DBAs 100 according to service requests. The virtual DBAs 100 may be a software program operating on a server, or may be a hardware module operating on a dedicated LSI. When receiving, for example, the service request illustrated in FIG. 4, the service control unit 311 starts the virtual DBA 100A for performing QoS control on this service. The virtual DBA 100A establishes connections with the ONU 10-1 and the ONU 10-2, according to the service request, and assigns and provides the LLIDs 11 and 21 and the queues 111 and 211 to this service. In this state, when the service control unit 311 further receives a new service request for the ONU 10-1, the service control unit 311 may assign the LLID 11 of the ONU 10-1 to assign the unused queue 112, or may assign the LLID 12.

Return to the description of FIG. 3. The service control unit 311 can generate the transfer rule table 312 that is transfer rule information, and the aggregation rule table 313 that is aggregation rule information, based on the results of generation of the virtual DBAs 100.

FIG. 5 is a diagram illustrating an example of the transfer rule table 312 illustrated in FIG. 3. The transfer rule table 312 indicates the correspondence relationships between transmission request sources and transfer destination virtual DBAs 100, and includes transmission source information for identifying the transmission request sources and transfer destination information indicating the transfer destination virtual DBAs 100 associated with the transmission source information. The transmission source information includes, for example, information identifying logical links connected to the transmission request sources and queues included in the logical links. The transfer rule table 312 illustrated in FIG. 5 includes the numbers of transmission source LLIDs and queues as the transmission source information, and includes the numbers of destination virtual DBAs 100 as the transfer destination information. Specifically, the queue 111 of the LLID 11 is associated with the virtual DBA 100A, the queue 211 of the LLID 21 is associated with the virtual DBA 100A, and the queue 112 of the LLID 11 is associated with the virtual DBA 100B.

Return to the description of FIG. 3. The transmission request analysis unit 314 analyzes the transmission requests output by the transmission request separation unit 32, and outputs analysis results to the transfer control unit 315. Based on the analysis results, the transfer control unit 315 extracts transmission requests from the REPORT frame, extracts, from the transmission requests, information indicating an LLID and queues as transmission source information, and information indicating the amounts of data in the queues, and selects transfer destination virtual DBAs 100 based on the extracted information and the transfer rule table 312. The transfer control unit 315 transfers the transmission requests to the selected virtual DBAs 100. For example, when the transmission source information of a transmission request indicates the queue 111 of the LLID 11, the transfer control unit 315, when using the transfer rule table 312 illustrated in FIG. 5, selects the virtual DBA 100A and transfers the transmission request to the selected virtual DBA 100A.

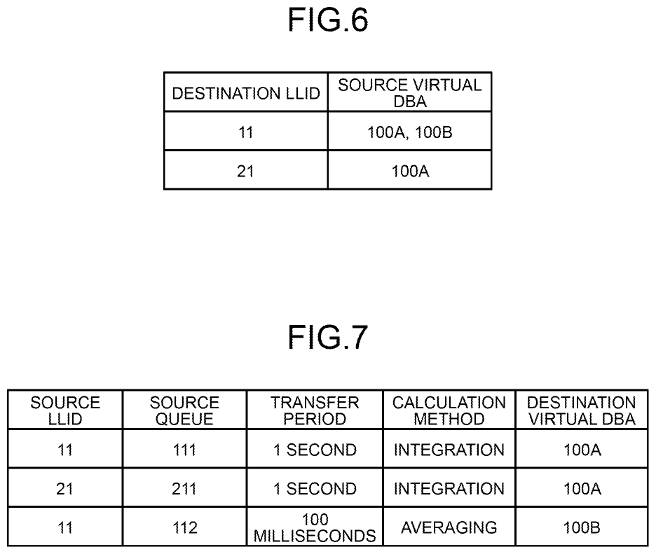

FIG. 6 is a diagram illustrating an example of the aggregation rule table 313 illustrated in FIG. 3. The aggregation rule table 313 indicates the correspondence relationships between transmission grant destinations and virtual DBAs 100 that can be transmission grant sources, and includes destination information for identifying the transmission grant destinations, and transmission source information indicating the virtual DBAs 100 that are the transmission grant sources and are associated with the destination information. Since the LLID 11 is used by the virtual DBA 100A and the virtual DBA 100B, the aggregation rule table 313 associates the virtual DBAs 100A and 100B as transmission sources with the LLID 11. Since the LLID 21 is used by the virtual DBA 100A, the aggregation rule table 313 associates the virtual DBA 100A as a transmission source with the LLID 21.

Based on the aggregation rule table 313, the aggregation control unit 316 aggregates transmission grants output by the virtual DBAs 100A and 100B for each destination. Specifically, the aggregation control unit 316 integrates allocated resources calculated by virtual DBAs 100 associated with each LLID to generate a transmission grant to each individual LLID. The aggregation control unit 316 outputs the generated transmission grants to the frame generation unit 317. The frame generation unit 317 generates GATE frames that are frames including the aggregated transmission grants output by the aggregation control unit 316, and outputs the generated GATE frames to the frame merging unit 33.

As described above, when receiving a transmission request, the OLT 30 according to the first embodiment selects a virtual DBA 100 that is the transfer destination of the received transmission request, based on the transfer rule table 312 that is the transfer rule information indicating the correspondence relationships between the transmission request sources and the transfer destination virtual DBAs 100, and transfers the transmission request to the selected virtual DBA 100. This allows calculation for providing a transmission grant to be performed only by a transfer destination virtual DBA 100, and can prevent an unnecessary increase in calculation resources and reduce resource waste.

Furthermore, the amounts of data in transmission grants are integrated, based on the aggregation rule table 313, and an aggregated transmission grant is generated to each destination of the transmission grants. Consequently, efficient notification of allocated resources becomes possible, and waste of resources required for notification can be reduced.

### Second Embodiment

A second embodiment is different from the first embodiment in the contents of the transfer rule table 312. FIG. 7 is a diagram illustrating an example of the transfer rule table 312 generated by the service control unit 311 according to the second embodiment. For a system configuration and functional configurations of devices in the second embodiment, the same parts as those in the first embodiment will not be described, and differences from the first embodiment will be mainly described below.

The transfer rule table 312 illustrated in FIG. 7 includes transfer periods and calculation methods in addition to transmission source LLIDs and transmission source queues that are transmission source information, and destination virtual DBAs indicating transfer destination virtual DBAs 100. The transfer periods indicate periods at which transmission requests are transferred to the virtual DBAs 100. The calculation methods indicate methods of calculating data included in transmission requests received by the transfer control unit 315 within the transfer periods.

In the PON system, transmission requests are typically collected at intervals of some milliseconds, but the transfer control unit 315 transfers transmission requests to the virtual DBAs 100 at periods specified by the transfer periods in the transfer rule table 312. When the services associated with the virtual DBAs 100 do not require high-frequency parameter adjustment, the specification of transfer period parameters as above can lengthen the transfer periods, thereby reducing the frequencies of calculations for giving transmission grants in the virtual DBAs 100, and reducing calculation resource waste. If necessary, it is possible to increase the frequency of calculations for giving transmission grants only for a service that requires high-frequency parameter adjustment.

For the calculation methods, for example, “integration”, “averaging”, etc. are specified as methods of calculating data included in transmission requests received within the transfer periods. When the transfer rule table 312 illustrated in FIG. 7 is used, for transmission requests to be transferred to the virtual DBA 100A, the transfer control unit 315 integrates the amounts of data in transmission requests received in one second, and transfers a transmission request including the integrated result to the virtual DBA 100A. For transmission requests to be transferred to the virtual DBA 100B, the transfer control unit 315 calculates the average amount of data in transmission requests received in 100 milliseconds, and transfers a transmission request including the average amount of data to the virtual DBA 100B. The transfer rule table 312 may specify part of processing to be performed by the virtual DBAs 100 as calculation methods. In this case, calculation times in the virtual DBAs 100 can be shortened, and calculation resources of the virtual DBAs 100 can be reduced.

As described above, the second embodiment allows the adjustment of the transmission request transfer periods according to requirements of the virtual DBAs 100. In this case, by increasing the transfer periods, the amounts of data to be transferred to the virtual DBAs 100 can be reduced. Furthermore, by specifying the methods of calculation of transmission requests received within the transfer periods, the transfer control unit 315 can reduce the amounts of data in transmission requests before transferring them, allowing the reduction of calculation resources in the virtual DBAs 100. Moreover, by specifying part of processing to be performed by the virtual DBAs 100 as calculation methods, it becomes possible to shorten calculation times in the virtual DBAs 100 and reduce calculation resources.

### Third Embodiment

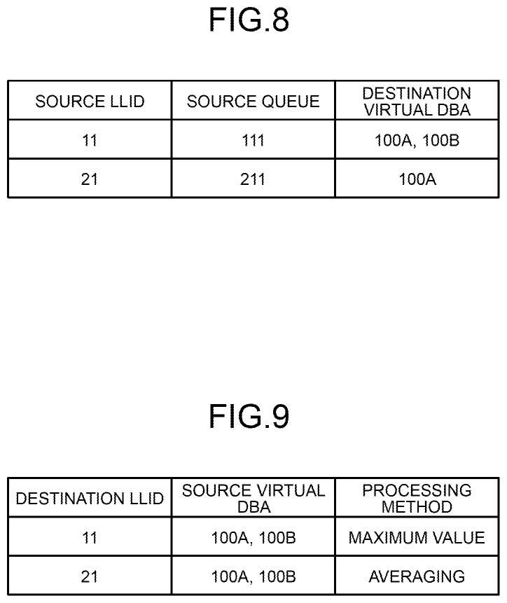

A third embodiment is different from the first embodiment in the contents of the transfer rule table 312 and the aggregation rule table 313. FIG. 8 is a diagram illustrating an example of the transfer rule table 312 generated by the service control unit 311 according to the third embodiment. FIG. 9 is a diagram illustrating an example of the aggregation rule table 313 generated by the service control unit 311 according to the third embodiment. For a system configuration and functional configurations of devices in the third embodiment, the same parts as those in the first embodiment will not be described, and differences from the first embodiment will be mainly described below.

In the transfer rule table 312 of the first embodiment, one destination is specified for one transmission source. In the transfer rule table 312 illustrated in FIG. 8, a plurality of destinations are specified for one transmission source. In this case, for example, a transmission request from the queue 111 of the LLID 11 is transferred to both of the virtual DBAs 100A and 100B, and calculations based on the same transmission request are performed in the virtual DBAs 100A and 100B. Consequently, a transmission grant calculated by the virtual DBA 100A and a transmission grant calculated by the virtual DBA 100B may result in redundant data allocation to the queue 111 of the LLID 11 as the same transmission source.

The aggregation rule table 313 illustrated in FIG. 9 includes processing method information specifying processing methods for aggregating allocated amounts of data included in transmission grants, in addition to destination LLIDs and transmission source virtual DBAs. For example, “maximum value”, “averaging”, etc. can be specified as the processing methods. The aggregation control unit 316 aggregates allocated amounts of data included in a plurality of transmission grants to the same destination, according to the processing method information. When using the aggregation rule table 313 illustrated in FIG. 9, the aggregation control unit 316 acquires the maximum value of an allocated amount of data allocated by the virtual DBA 100A in a transmission grant to the LLID 11, and an allocated amount of data allocated by the virtual DBA 100B in a transmission grant to the LLID 11, and notifies the LLID 11 of a transmission grant including the maximum value. The aggregation control unit 316 takes the average value of an allocated amount of data allocated by the virtual DBA 100A in a transmission grant to the LLID 21 and an allocated amount of data allocated by the virtual DBA 100B in a transmission grant to the LLID 21, and notifies the LLID 21 of a transmission grant including the average value.

As described above, in the third embodiment, in which the processing methods are specified in the aggregation rule table 313, and the aggregation control unit 316 performs an operation to aggregate a plurality of transmission grants, thus allows the reduction of excessive resource allocation to the same LLID even when a plurality of virtual DBAs 100 generate transmission grants based on the same transmission request.

### Fourth Embodiment

A fourth embodiment is different from the first embodiment in the configuration of the ONUs 10 and the transfer rule table 312. Hereinafter, the same parts as those of the first embodiment will not be described in detail, and differences from the first embodiment will be mainly described.

A frame format of transmission requests transmitted by the ONUs 10 is as illustrated in FIG. 2. A REPORT frame transmitted by the ONUs 10 can include a plurality of transmission requests as queue sets. Here, queue sets are prepared on an individual service basis, so that even when services use a plurality of queues, transmission requests can be transferred to the corresponding virtual DBAs 100 by sharing the queues with the other services. In other words, queue set numbers can be used as service identification information.

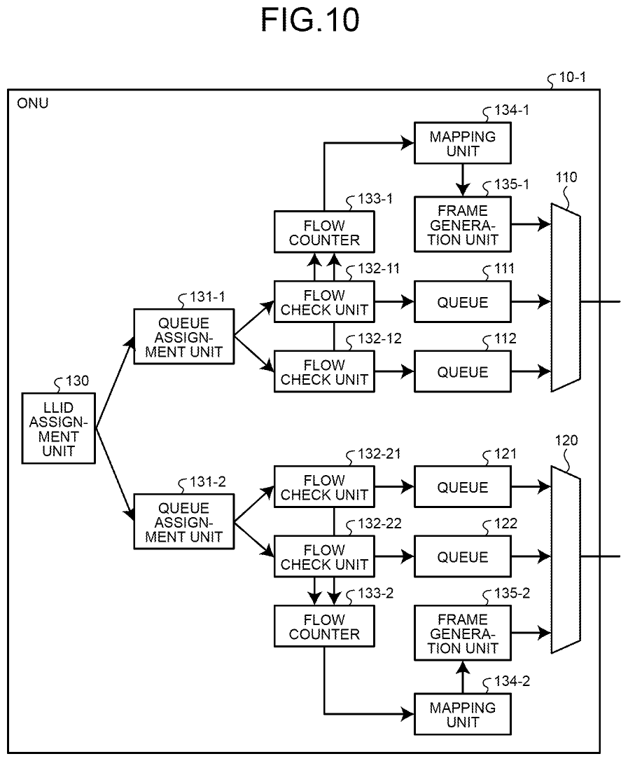

FIG. 10 is a functional block diagram of the ONU 10-1 according to the fourth embodiment. The ONU 10-1 includes, in addition to the queues 111, 112, 121, and 122 and the frame reading units 110 and 120, an LLID assignment unit 130, queue assignment units 131-1 and 131-2, flow check units 132-11, 132-12, 132-21, and 132-22, flow counters 133-1 and 133-2, mapping units 134-1 and 134-2, and frame generation units 135-1 and 135-2.

The LLID assignment unit 130 assigns input communication traffic to different LLIDs for each service. The LLID assignment unit 130 outputs the communication traffic assigned to the LLID 11 to the queue assignment unit 131-1, and outputs the communication traffic assigned to the LLID 12 to the queue assignment unit 131-2.

The queue assignment units 131 assign the input communication traffic to different queues for each service. The queue assignment unit 131-1 outputs the communication traffic assigned to the queue 111 to the flow check unit 132-11, and outputs the communication traffic assigned to the queue 112 to the flow check unit 132-12. The queue assignment unit 131-2 outputs the communication traffic assigned to the queue 121 to the flow check unit 132-21, and outputs the communication traffic assigned to the queue 122 to the flow check unit 132-22.

The flow check units 132 perform service identification on the communication traffic assigned to the queues by the LLID assignment unit 130 and the queue assignment units 131, and measure the amounts of data. The flow check units 132 output the communication traffic to the corresponding queues, and output the measured amounts of data and service identification information associated with each other to the flow counters 133. Specifically, the flow check unit 132-11 outputs the communication traffic to the queue 111, and outputs the measured amount of data and the service identification information associated with each other to the flow counter 133-1. The flow check unit 132-12 outputs the communication traffic to the queue 112, and outputs the measured amount of data and the service identification information associated with each other to the flow counter 133-1. The flow check unit 132-21 outputs the communication traffic to the queue 121, and outputs the measured amount of data and the service identification information associated with each other to the flow check unit 133-2. The flow check unit 132-22 outputs the communication traffic to the queue 122, and outputs the measured amount of data and the service identification information associated with each other to the flow check unit 133-2.

The flow counters 133 integrate and aggregate the amounts of data for each service, based on the amounts of data and the identification information output from the flow check units 132. The flow counters 133 output the aggregate results to the mapping units 134. Specifically, the flow counter 133-1 outputs the aggregate results to the mapping unit 134-1, and the flow counter 133-2 outputs the aggregate results to the mapping unit 134-2.

The mapping units 134 map the amounts of data in the queues of each service to the REPORT frame format, based on the aggregate results from the flow counters 133, to compile them as queue sets. The mapping units 134 output compiled information to the frame generation units 135. Specifically, the mapping unit 134-1 outputs the compiled information to the frame generation unit 135-1, and the mapping unit 134-2 outputs the compiled information to the frame generation unit 135-2.

The frame generation units 135 generate REPORT frames including the information output from the mapping units 134. The frame reading unit 110 reads frames from the frame generation unit 135-1 and the queues 111 and 112, and transmits the frames to the OLT 30. Likewise, the frame reading unit 120 reads frames from the frame generation unit 135-2 and the queues 121 and 122, and transmits the frames to the OLT 30.

Although the functional configuration of the ONU 10-1 has been described in FIG. 10, the ONU 10-2 can also have the same configuration.

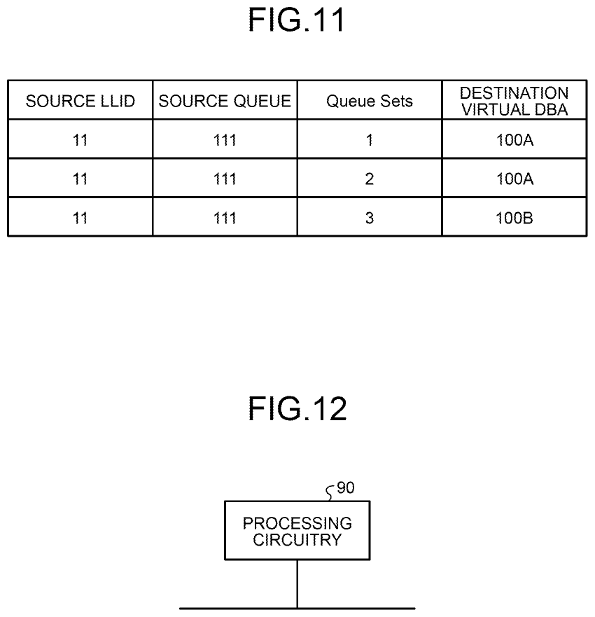

FIG. 11 is a diagram illustrating an example of the transfer rule table 312 used by the OLT 30 that receives a REPORT frame including transmission requests from the ONU 10-1 illustrated in FIG. 10. Here, an example is illustrated in which the queue 111 of the LLID 11 is shared by a plurality of services. The transfer rule table 312 illustrated in FIG. 11 includes queue sets that are service identification information, in addition to a transmission source LLID and a transmission source queue that are transmission source information, and destination virtual DBAs. The transfer rule table 312 including the service identification information allows the transfer control unit 315 that has received a REPORT frame including transmission requests to select a transfer destination virtual DBA 100 for each queue set in the REPORT frame in addition to the transmission source information. Thus, the transfer control unit 315 can select a transfer destination for each service even when transmission source information is the same.

As described above, according to the fourth embodiment, transfer rule information used by the OLT 30 includes queue set numbers usable as service identification information, and the transfer control unit 315 selects a virtual DBA 100 associated with each queue set and transfers a transmission request to the selected virtual DBA 100. Each ONU 10 as a transmission request source includes the flow check units 132 that measure the amounts of data of each service, the flow counters 133 that aggregates the amounts of data of each service, based on the results of the measurement of the flow check units 132, and the mapping units 134 that map the service identification information and the amounts of data of each service to the REPORT frame format including transmission requests, based on the results of the aggregation of the flow counters 133. With this configuration, even when queues are shared by a plurality of services in the ONU 10, the OLT 30 can select a virtual DBA 100 for each service and transfer a transmission request to the selected virtual DBA 100. Consequently, it becomes possible to reduce resource waste, and allocate an appropriate amount of data to each service.

A hardware configuration of the OLT 30 and the ONUs 10 according to the above-described first to fourth embodiments will be described. Each function of the OLT 30 and the ONUs 10 is implemented by processing circuitry. The processing circuitry may be implemented by dedicated hardware, or may be a control circuit using a central processing unit (CPU).

When implemented by dedicated hardware, the processing circuitry is implemented by processing circuitry 90 illustrated in FIG. 12. FIG. 12 is a diagram illustrating dedicated hardware for implementing the functions of the OLT 30 and the ONUs 10 according to the first to fourth embodiments. The processing circuitry 90 is a single circuit, a combined circuit, a programmed processor, a parallel-programmed processor, an application specific integrated circuit (ASIC), a field programmable gate array (FPGA), or a combination of them.

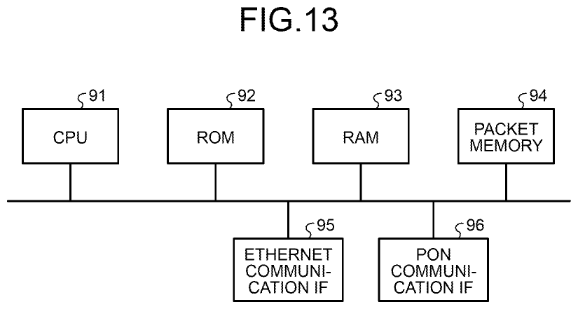

When the processing circuitry is implemented by a control circuit using a CPU, each of the OLT 30 and the ONUs 10 may be implemented, for example, by a hardware configuration illustrated in FIG. 13. FIG. 13 is a diagram illustrating an example of a configuration for implementing the functions of the OLT 30 and the ONUs 10 according to the first to fourth embodiments, using a CPU. Each of the OLT 30 and the ONUs 10 includes, for example, a CPU 91, read only memory (ROM) 92, random access memory (RAM) 93, packet memory 94, an Ethernet (registered trademark) communication interface (IF) 95, and a PON communication IF 96.

The CPU 91 is an example of a processor, and is also called an arithmetic device, a microprocessor, a microcomputer, a digital signal processor (DSP), or the like. The ROM 92, the RAM 93, and the packet memory 94 are examples of memory. When the CPU 91 is used, the function of each unit of the OLT 30 and the ONUs 10 is implemented by software, firmware, or a combination of software and firmware. Software and firmware are described as a program and stored in the memory. The CPU 91 reads and executes the program stored in the memory, thereby implementing the function of each unit. The program may be provided in a state of being stored on a storage medium, or may be provided via a communication path.

Each of the functions of the units of the OLT 30 and the ONUs 10 may be implemented by individual processing circuitry, or two or more of the functions may be collectively implemented by one processing circuitry. The function of each unit may be partly implemented by dedicated hardware and partly implemented by software, firmware, or the like.

The optical line terminal according to the present disclosure has the effect of being able to reduce resource waste.

The configurations described in the above embodiments illustrate an example and can be combined with another known art. The embodiments can be combined with each other. The configurations can be partly omitted or changed without departing from the gist.

What is claimed is:

1. An optical line terminal on an operator side to operate a plurality of virtual dynamic bandwidth allocation units to, according to a transmission request transmitted by an optical network unit on a subscriber side, calculate bandwidth to be allocated to a transmission source of the transmission request and output a transmission grant, the optical line terminal comprising:
service control circuitry to generate the plurality of virtual dynamic bandwidth allocation units according to service requests;
transfer control circuitry to, when receiving the transmission request, select the virtual dynamic bandwidth allocation unit that is a transfer destination of the received transmission request, based on transfer rule information indicating a correspondence relationship between the transmission source of the transmission request and the virtual dynamic bandwidth allocation unit that is the transfer destination, and transfer the transmission request to the selected virtual dynamic bandwidth allocation unit; and
aggregation control circuitry to aggregate the transmission grants output by the virtual dynamic bandwidth allocation units, based on aggregation rule information indicating correspondence relationships between destinations of the transmission grants and the virtual dynamic bandwidth allocation units that are possibly transmission sources of the transmission grants.

2. The optical line terminal according to claim 1, wherein the service control circuitry generates the transfer rule information and the aggregation rule information, based on results of the generation of the virtual dynamic bandwidth allocation units.

3. The optical line terminal according to claim 1, wherein the transfer rule information includes transmission source information for identifying the transmission source of the transmission request, and transfer destination information indicating the virtual dynamic bandwidth allocation unit that is the transfer destination associated with the transmission source information.

4. The optical line terminal according to claim 3, wherein
the transmission source information includes information identifying a logical link connected to the transmission source of the transmission request and a queue included in the logical link, and
the transfer control circuitry extracts, when receiving the transmission request, information identifying the logical link and the queue from the received transmission request, and selects the virtual dynamic bandwidth allocation unit associated with the logical link and the queue extracted, based on the transfer rule information.

5. The optical line terminal according to claim 1, wherein
the transfer rule information further includes transfer period information indicating a period at which a transmission request is transferred to the virtual dynamic bandwidth allocation unit, and
the transfer control circuitry transfers the transmission request at the period based on the transfer period information.

6. The optical line terminal according to claim 5, wherein
the transfer rule information further includes calculation method information specifying a method of calculating data included in the transmission requests received by the transfer control circuitry within the period indicated by the transfer period information, and
the transfer control circuitry transfers the transmission request after processing the transmission requests according to the calculation method information.

7. The optical line terminal according to claim 6, wherein the calculation method information specifies part of processing to be performed by the virtual dynamic bandwidth allocation unit to receive the transmission request.

8. The optical line terminal according to claim 1, wherein
the aggregation rule information includes destination information for identifying the destinations of the transmission grants, and transmission source information indicating the virtual dynamic bandwidth allocation units that are the transmission sources of the transmission grants and are associated with the destination information, and
the aggregation control circuitry aggregates the transmission grants for each destination of the transmission grants.

9. The optical line terminal according to claim 8, wherein
the aggregation rule information further includes processing method information specifying a processing method for aggregating allocated amounts of data included in the transmission grants, and
the aggregation control circuitry aggregates the allocated amounts of data included in a plurality of transmission grants to the same destination, according to the processing method information.

10. The optical line terminal according to claim 9, wherein
the processing method is to take a maximum value or an average value of the allocated amounts of data, and
the aggregation control circuitry takes the maximum value or the average value of the allocated amounts of data, according to the processing method information, and transmits the maximum value or the average value to the destination of the transmission grants.

11. An optical access network system, comprising:
an optical network unit on a subscriber side to transmit a transmission request; and
the optical line terminal according to claim 1 to receive the transmission request.

12. The optical access network system according to claim 11, wherein
the transfer rule information includes service identification information,
the transfer control circuitry selects the virtual dynamic bandwidth allocation unit that is the transfer destination, based on the service identification information, and
the optical network unit on the subscriber side includes
flow check circuitry to measure an amount of data of each service,
a flow counter to aggregate the amount of data of each service, based on results of the measurement of the flow check circuitry, and
mapping circuitry to map the service identification information and the amount of data of each service to a format of a frame including the transmission request, based on results of the aggregation of the flow counter.

13. An optical communication method for a virtual dynamic bandwidth allocation unit operated by an optical line terminal on an operator side to, according to a transmission request transmitted by an optical network unit on a subscriber side, calculate bandwidth to be allocated to a transmission source of the transmission request and output a transmission grant, the optical communication method comprising:
generating a plurality of the virtual dynamic bandwidth allocation units according to service requests;
selecting, when receiving the transmission request, the virtual dynamic bandwidth allocation unit that is a transfer destination of the received transmission request, based on transfer rule information indicating a correspondence relationship between the transmission source of the transmission request and the virtual dynamic bandwidth allocation unit that is the transfer destination;
transferring the transmission request to the selected virtual dynamic bandwidth allocation unit; and
aggregating the transmission grants output by the virtual dynamic bandwidth allocation units, based on aggregation rule information indicating correspondence relationships between destinations of the transmission grants and the virtual dynamic bandwidth allocation units that are possibly transmission sources of the transmission grants.
